(19) United States
(12) Patent Application Publication
(10) Pub. No.: US 2007/0002724 A1
(43) Pub. Date: Jan. 4, 2007

(54) Apparatus and method for broadcast superposition and cancellation in a multi-carrier wireless network

(75) Inventor: Farooq Khan, Allen, TX (US)

Correspondence Address: DOCKET CLERK, P.O. DRAWER 800889, DALLAS, TX, 75380, US

(73) Assignee: SAMSUNG ELECTRONICS CO., LTD., SUWON-CITY (KR)

(21) Appl. No.: 11/414,814

(22) Filed: May 1, 2006

Related U.S. Application Data
(60) Provisional application No. 60/690,846, filed on Jun. 15, 2005.
(60) Provisional application No. 60/690,743, filed on Jun. 15, 2005.

(51) Int. Cl. H04J 11/00

(52) U.S. Cl. 370/203

(57) ABSTRACT

A base station for use in an orthogonal frequency division multiplexing (OFDM) wireless network capable of communicating with a plurality of subscriber stations in a coverage area of the OFDM wireless network. The base station transmits a first OFDM symbol in a first time slot, wherein the first OFDM symbol comprises a first plurality of subcarriers in which broadcast data directed to a first plurality of subscriber stations is superimposed on unicast data directed to at least one selected subscriber station.

### CROSS-REFERENCE TO RELATED APPLICATIONS AND CLAIMS OF PRIORITY

The present application is related to U.S. Provisional Patent No. 60/690,846, filed Jun. 15, 2005, entitled “Multiplexing of Broadcast and Unicast Traffic” and U.S. Provisional Patent No. 60/690,743, filed Jun. 15, 2005, entitled “Broadcast Superposition and Interference Cancellation”. U.S. Provisional Patent Nos. 60/690,846 and 60/690,743 are assigned to the assignee of this application and are incorporated by reference as if fully set forth herein. The present application hereby claims priority under 35 U.S.C. §119(e) to U.S. Provisional Patent Nos. 60/690,846 and 60/690,743.

The present application is related to U.S. Patent Application Serial No. [2005.06.001.WS0], entitled “Apparatus and Method for Multiplexing Broadcast and Unicast Traffic in a Multi-Carrier Wireless Network,” filed concurrently herewith. Application Serial No. [2005.06.001.WS0] is assigned to the assignee of this application. The subject matter disclosed in Application Serial No. [2005.06.001.WS0] is incorporated by reference as if fully set forth herein.

### TECHNICAL FIELD OF THE INVENTION

The present application relates generally to wireless communications and, more specifically, to apparatuses and methods for superposition of broadcast and unicast traffic and interference cancellation in a multicarrier wireless network.

### BACKGROUND OF THE INVENTION

Orthogonal frequency division multiplexing (OFDM) is a multi-carrier transmission technique in which a user transmits on many orthogonal frequencies (or subcarriers). The orthogonal subcarriers are individually modulated and separated in frequency such that they do not interfere with one another. This provides high spectral efficiency and resistance to multipath effects. An orthogonal frequency division multiple access (OFDMA) system allows some subcarriers to be assigned to different users, rather than to a single user. Today, OFDM and OFDMA technology are used in both wireline transmission systems, such as asymmetric digital subscriber line (ADSL), and wireless transmission systems, such as IEEE-802.11a/g (i.e., WiFi), IEEE-802.16 (e.g., WiMAX), digital audio broadcast (DAB), and digital video broadcast (DVB). This technology is also used for wireless digital audio and video broadcasting.

OFDM networks support the transmission of both broadcast traffic, intended for multiple subscriber stations (i.e., user devices), and unicast traffic, intended for a single subscriber station. Conventional OFDM networks time-multiplex broadcast and unicast traffic in the downlink (i.e., forward channels) by transmitting broadcast and unicast traffic in different downlink transmission time intervals. Accordingly, broadcast traffic may be transmitted in a first transmission time interval (TTI), while unicast traffic is transmitted in at least one TTI other than the first TTI. In general, the duration of each TTI is fixed. The number of OFDM symbols within a TTI may be different for broadcast traffic and unicast traffic. In general, a smaller number of OFDM symbols are carried in a broadcast TTI in order to allow for a longer cyclic prefix (CP).

By way of example, an OFDM network may transmit a 5 millisecond frame in the downlink. Each downlink frame contains eight transmission time intervals, where each TTI is 0.625 milliseconds in duration. Every fourth TTI is reserved for broadcast traffic. Each unicast TTI contains K OFDM symbols and each broadcast TTI contains less than K OFDM symbols.

The signal-to-interference and noise ratio (SINR) for unicast traffic may be written as:

$${SINR}_{unicast} = \frac{P}{fP + {N}_{0}} , \qquad [ Eqn . 1 ]$$

where the value P represents the received power at the subscriber station from the same cell and the value f represents the ratio between other cell and same cell signals. In an interference limited situation, which is the case for most cellular deployments, fP>>N₀. Therefore, SINR may be written as:

$${SINR}_{unicast} = \frac{P}{fP + {N}_{0}} = \frac{P}{fP} = \frac{1}{f} . \qquad [ Eqn . 2 ]$$

It should be noted that increasing the power, P, does not help to improve unicast SINR.

In the case of broadcast traffic using OFDM, the signals received by a subscriber station from multiple synchronized base stations are orthogonal as long as the relative delays of the received signals are within the OFDM symbol cyclic prefix length. Therefore, there is no interference when the same broadcast content is transmitted system-wide, apart from the background noise. The average SINR in an OFDM-based broadcast is given as:

$${SINR}_{broadcast} = \frac{KP}{{N}_{0}} , \qquad \{ Eqn . 3 \}$$

where the value P is the received power from one base station at the subscriber station and the value K is the number of base stations from which broadcast content is received, assuming equal power is received from K base stations. It should be noted that increasing transmit power results in a linear increase of broadcast SINR.

However, conventional OFDM networks that time-multiplex broadcast and unicast traffic suffer wasted power during unicast traffic transmissions. The reason for this wasted power is that transmitting at a higher power does not help to improve SINR for unicast traffic during unicast traffic transmission periods, due to increased interference from neighboring cells. As a result, the same performance may be achieved by transmitting unicast traffic at reduced power. However, the additional available power cannot be used for broadcast traffic, because broadcast traffic transmissions occur in different time slots (i.e., TTIs) than unicast traffic transmissions. Since either broadcast traffic or unicast traffic, but not both, may be transmitted during a given TTI, it is not possible to allocate the available downlink power adaptively between unicast and broadcast traffic. This results in system inefficiency

Therefore, there is a need for improved OFDM (or OFDMA) transmission systems that make better use of the available downlink transmit power.

### SUMMARY OF THE INVENTION

In one embodiment of the present disclosure, a base station is provided for use in an orthogonal frequency division multiplexing (OFDM) wireless network capable of communicating with a plurality of subscriber stations in a coverage area of the OFDM wireless network. The base station is capable of transmitting a first OFDM symbol in a first time slot, wherein the first OFDM symbol comprises a first plurality of subcarriers in which broadcast data directed to a first plurality of subscriber stations is superimposed on unicast data directed to at least one selected subscriber station.

In another embodiment of the present disclosure, a method is provided for transmitting broadcast and unicast data to the subscriber stations. The method comprises the step of transmitting a first OFDM symbol in a first time slot, wherein the first OFDM symbol comprises a first plurality of subcarriers in which broadcast data directed to a first plurality of subscriber stations is superimposed on unicast data directed to at least one selected subscriber station.

In another embodiment, a base station is provided for use in an OFDM wireless network capable of communicating with a plurality of subscriber stations in a coverage area of the OFDM wireless network. The base station is capable of transmitting a first OFDM symbol in a first time slot from a first antenna and a second OFDM symbol in the first time slot from a second antenna. The first OFDM symbol comprises a first plurality of subcarriers that transmit broadcast data to a first plurality of subscriber stations and the second OFDM symbol comprises a second plurality of subcarriers that transmit unicast data to at least one selected subscriber station. At least some of the first plurality of subcarriers and the second plurality of subcarriers are the same subcarriers, such that the broadcast data is superimposed on the unicast data during transmission over the air.

In still another embodiment, a first subscriber station is provided for communicating with an OFDM wireless network. The first subscriber station receives a first OFDM symbol in a first time slot, wherein the first OFDM symbol comprises a first plurality of subcarriers in which broadcast data directed to a first plurality of subscriber stations is superimposed on unicast data directed to at least one selected subscriber station. The first subscriber station comprises broadcast demodulation and decoding circuitry for receiving broadcast pilot signals and combined broadcast and unicast data generated from the received first OFDM symbol and extracting a broadcast data stream from the combined broadcast and unicast data. The first subscriber station further comprises cancellation circuitry for cancelling the extracted broadcast data stream from the combined broadcast and unicast data to thereby recover unicast data directed to the first subscriber station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that superimposes broadcast traffic on unicast traffic in the downlink according to the principles of the present disclosure;

FIG. 2 is a high-level diagram of an OFDM base station according to one embodiment of the present disclosure;

FIG. 3 illustrates an exemplary subscriber station in greater detail according to one embodiment of the disclosure;

FIG. 4 is a high-level diagram of an OFDM base station that superimposes broadcast traffic on unicast traffic in the downlink according to an alternate embodiment of the disclosure;

FIG. 5 is a high-level diagram of an alternate embodiment of a base station that uses Hadamard Transforms;

FIG. 6 is a high-level diagram of an alternate embodiment of a base station that uses FFT pre-coding; and

FIG. 7 illustrates an exemplary subscriber station in greater detail according to one embodiment of the disclosure.

### DETAILED DESCRIPTION OF THE INVENTION

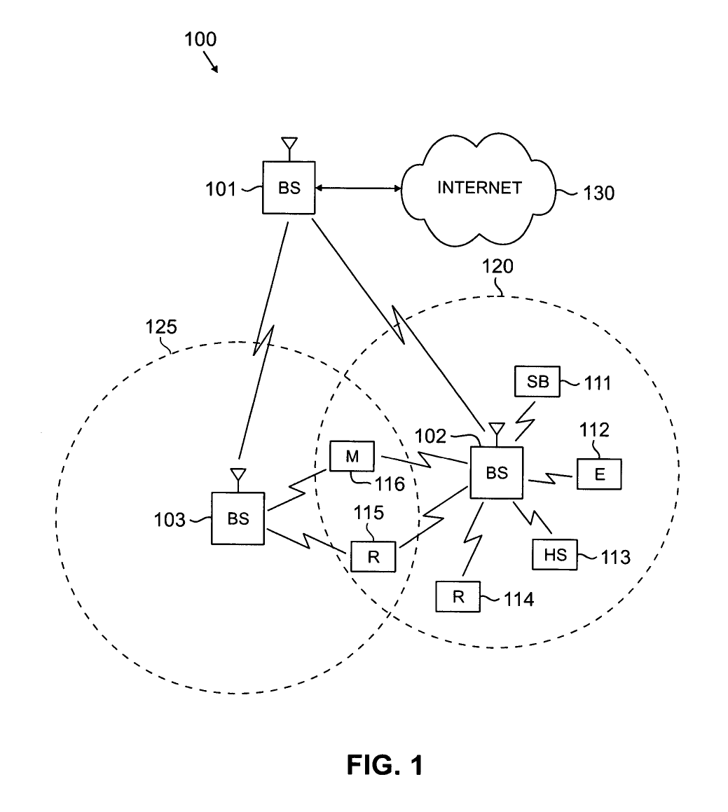

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

The present disclosure is directed to a transmission technique in which broadcast traffic is superimposed on unicast traffic in the downlink. The superimposed broadcast signal is decoded and cancelled at a receiver that recovers the unicast signal. This provides simultaneous transmission of broadcast and unicast traffic using the same subcarrier resources and therefore also allows for adaptive power allocation between broadcast traffic and unicast traffic. This results in higher spectral efficiency.

FIG. 1 illustrates exemplary wireless network 100, which superimposes broadcast traffic on unicast traffic in the downlink according to the principles of the present disclosure. In the illustrated embodiment, wireless network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based network (not shown).

Base station 102 provides wireless broadband access (via base station 101) to Internet 130 to a first plurality of subscriber stations within coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access (via base station 101) to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using OFDM or OFDMA techniques.

Base station 101 may be in communication with either a greater number or a lesser number of base stations. Furthermore, while only six subscriber stations are depicted in FIG. 1, it is understood that wireless network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

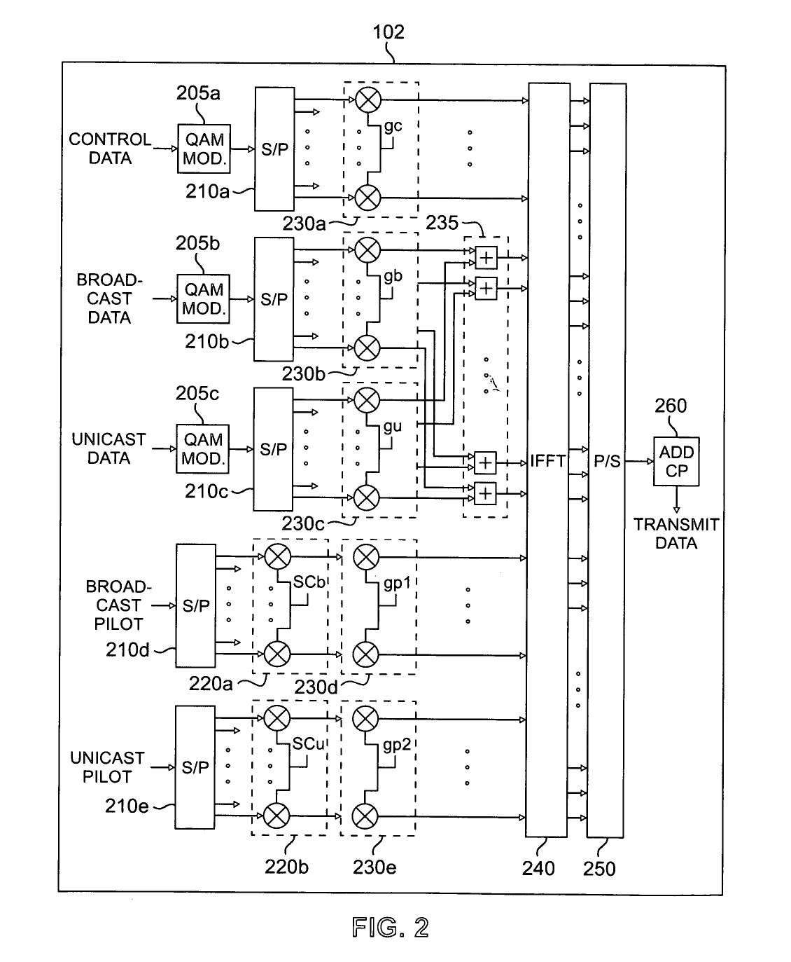

FIG. 2 is a high-level diagram of base station 102, which superimposes broadcast traffic on unicast traffic in the downlink according to the principles of the present disclosure. Base station 102 comprises a plurality of quadrature amplitude modulation (QAM) blocks 205, including exemplary QAM blocks 205a, 205b and 205c, and a plurality of serial-to-parallel (S/P) blocks 210, including exemplary S/P blocks 210a, 210b, 210c, 210d and 210e. Base station (BS) 102 further comprises scrambling code multiplier blocks 220a and 220b, a plurality of gain multiplier blocks 230, including exemplary gain multiplier blocks 230a, 230b, 230c, 230d and 230e, adder block 235, inverse Fast Fourier Transform (IFFT) block 240, parallel-to-serial (P/S) block 250, and add cyclic prefix (CP) block 260. At least some of the components in FIG. 2 may be implemented in software while other components may be implemented by configurable hardware or a mixture of software and configurable hardware. In particular, it is noted that the IFFT block in FIG. 2 may be implemented as configurable software algorithms, where the value of IFFT size may be modified according to the implementation.

Streams of broadcast data symbols, unicast data symbols, and control data symbols (e.g., pilot signal, ACK/NACK messages) are separately coded (not shown) using a channel code, such as convolutional code, Turbo code or low-density parity check (LDPC) code. The coded broadcast, unicast and control symbols are applied to the inputs of QAM blocks 210a-c. QAM block 210a modulates the control symbol stream to produce a first sequence of frequency-domain modulation symbols. QAM block 210b modulates the broadcast symbol stream to produce a second sequence of frequency-domain modulation symbols. The broadcast symbol stream comprises one stream of broadcast data directed to a plurality of subscriber stations. QAM block 210c modulates the unicast symbol stream to produce a third sequence of frequency-domain modulation symbols. The unicast symbol stream may comprise a single unicast data stream directed to a single subscriber station or may comprise a plurality of unicast data substreams, where each unicast data substream is directed to a different subscriber station.

S/P block 210a converts (i.e., de-multiplexes) to parallel format the first sequence of serial QAM control symbols from QAM block 205a and selectively maps the parallel format QAM control symbols to selected OFDM subcarriers at the inputs of IFFT block 240. However, each of the QAM control symbols from S/P block 210a is first multiplied (i.e., scaled) by a control gain factor, gc, by one of the multipliers in gain multiplier block 230a. The amplitude-scaled QAM control symbols are then applied to the selected inputs of IFFT block 240.

Similarly, S/P block 210b converts (de-multiplexes) to parallel format the second sequence of serial QAM broadcast symbols from QAM block 205b and selectively maps the parallel format QAM broadcast symbols to selected OFDM subcarriers at the inputs of IFFT block 240. However, each of the QAM broadcast symbols from S/P block 210b is first multiplied (scaled) by a broadcast gain factor, gb, by one of the multipliers in gain multiplier block 230b. The amplitude-scaled QAM broadcast symbols are then applied to the inputs of the adders in adder block 235 and are added to corresponding amplitude-scaled QAM unicast symbols from gain multiplier block 230c. The sums from adder block 235 are applied to the selected inputs of IFFT block 240.

Likewise, S/P block 210c converts (de-multiplexes) to parallel format the third sequence of serial QAM unicast symbols from QAM block 205c and selectively maps the parallel format QAM unicast symbols to selected OFDM subcarriers at the inputs of IFFT block 240. However, each of the QAM unicast symbols from S/P block 210c is first multiplied (scaled) by a unicast gain factor, gu, by one of the multipliers in gain multiplier block 230c. The amplitude-scaled QAM unicast symbols are then added to corresponding amplitude-scaled QAM broadcast symbols from gain multiplier block 230b.

The addition operation performed by adder block 235 superimposes the broadcast data on the unicast data. Adder block 235 adds the broadcast and unicast symbols and maps the combined symbols to OFDM subcarriers at the input of IFFT block 240. The overall broadcast signal is superimposed on the overall unicast signal on a subcarrier-by-subcarrier basis, so that the broadcast symbol corresponding to subcarrier j is superimposed on (i.e., added to) the unicast symbol corresponding to subcarrier j. Thus, twice as much information may be transmitted relative to an implementation in which there is no superposition. In this example, it is assumed that a broadcast symbol is superimposed on a unicast symbol for each subcarrier. However, this is not required and may not be true in most cases. In most situations, the amount of unicast data will be greater than the amount of broadcast data, so that broadcast data will be superimposed on unicast data for only some, but not all, subcarriers.

In order to provide coherent demodulation of broadcast and unicast traffic, reference pilot symbols may be transmitted from base station 101-103 to subscriber stations 111-116. For broadcast data, the same content is transmitted from multiple base stations, so that an overall channel estimate based on transmissions from multiple base stations is required for accurate demodulation of broadcast traffic. However, unicast traffic is transmitted from only a single base station, so that a channel estimate is needed from only a single base station to a subscriber station.

Thus, two different pilot signals are transmitted from a base station when broadcast traffic is superimposed on unicast traffic. In order to differentiate these two pilot signals at the subscriber station, a broadcast scrambling code (SCb) scrambles the broadcast pilot signal and a unicast scrambling code (SCu) scrambles the unicast pilot signal. The unicast scrambling code, SCu, may be different from one base station to another. However, the broadcast scrambling code (SCb) may be common among all the base stations transmitting the same broadcast content.

S/P block 210d receives a known stream of broadcast pilot symbols and converts (de-multiplexes) the broadcast pilot symbols to parallel format. S/P block 210d selectively maps the broadcast pilot symbols to selected OFDM subcarriers at the inputs of IFFT block 240. However, each of the broadcast pilot symbols from S/P block 210d is first multiplied by a broadcast scrambling code, SCb, by one of the multipliers in scrambling code multiplier block 220a and is then multiplied (scaled) by a broadcast pilot gain factor, gp1, by one of the multipliers in gain multiplier block 230d. The scrambled and scaled broadcast pilot symbols are then applied to the selected inputs of IFFT block 240.

S/P block 210e receives a known stream of unicast pilot symbols and converts (de-multiplexes) the unicast pilot symbols to parallel format. S/P block 210e selectively maps the unicast pilot symbols to selected OFDM subcarriers at the inputs of IFFT block 240. However, each of the unicast pilot symbols from S/P block 210e is first multiplied by a unicast scrambling code, SCu, by one of the multipliers in scrambling code multiplier block 220b and is then multiplied (scaled) by a unicast pilot gain factor, gp2, by one of the multipliers in gain multiplier block 230e. The scrambled and scaled unicast pilot symbols are then applied to the selected inputs of IFFT block 240.

In FIG. 2, scrambling codes are used only with the broadcast pilot signals and the unicast pilot signals. However, this is by way of illustration only and should not be construed to limit the scope of the disclosure. Those skilled in the art will appreciate that scrambling code multipliers 220 may also be inserted at the outputs of S/P block 210b and S/P block 210c in order to scramble the broadcast data symbols and the unicast data symbols.

IFFT block 240 then performs a size N IFFT operation on the N inputs received from gain multiplier block 230a, adder block 235, and gain multiplier blocks 230d and 230e, and produces N outputs. IFFT block 240 may receive M1 inputs of control data from gain multiplier block 230a, M2 inputs of combined broadcast and unicast data from adder block 235, M3 inputs of broadcast pilot signal from gain multiplier block 230d, and M4 inputs of unicast pilot signal from gain multiplier block 230b. The sum M1+M2+M3+M4 is less than or equal to the size N of IFFT block 240. In some embodiments, the unicast and broadcast pilot signals may be transmitted in different time slots than the unicast symbols, broadcast symbols, and control symbols. In that case, the sum M1+M2 is less than or equal to the size N of IFFT block 240 during time slots in which the unicast symbols, broadcast symbols, and control symbols are transmitted and the sum M3+M4 is less than or equal to the size N of IFFT block 240 during time slots in which the unicast and broadcast pilot signals are transmitted.

It is noted that not all of the M2 inputs from adder block 235 may comprise combined broadcast and unicast data. If the amount of unicast data is larger than the amount of broadcast data (a likely scenario), or vice versa, only some of the M2 inputs from adder block 235 will comprise combined broadcast and unicast data, while other ones of the M2 inputs from adder block 235 will comprise just unicast data (most likely) or just broadcast data. Also, in some embodiments, all inputs from gain multiplier block 230c may represent a single unicast data stream being transmitted to a single subscriber station during one time slot. Alternatively, these inputs may be divided into two or more subgroups of subcarriers, where each subgroup of subcarriers represents a single unicast data stream being transmitted to a single subscriber station during one time slot.

The N outputs from IFFT block 240 are parallel-to-serial converted by P/S block 250 to produce a serial data stream of combined symbols. Finally, add cyclic prefix block 260 adds a cyclic prefix to the output of IFFT block 250 prior to up-conversion (not shown) and transmission.

According to the principles of the present disclosure, base station 102 is capable of modifying the values of the broadcast gain factor, gb, and the unicast gain factor, gu, in order to allocate transmit power in the downlink between broadcast traffic and unicast traffic. This provides a capability of sharing power between broadcast and unicast data.

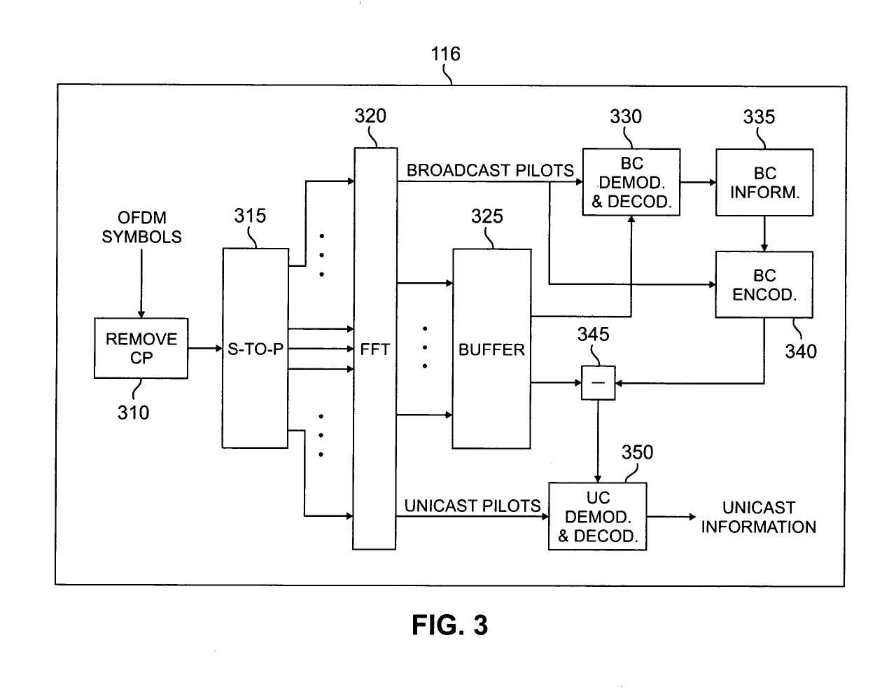

FIG. 3 illustrates exemplary subscriber station (SS) 116 in greater detail according to one embodiment of the present disclosure. FIG. 3 illustrates the functional blocks that perform interference cancellation of the broadcast signal in the OFDM receiver of SS 116. After down-conversion (not shown) of the received RF signal, remove cyclic prefix (CP) block 310 receives the incoming OFDM symbols and removes the cyclic prefix associated with each OFMD symbol. Serial-to-parallel block 315 converts the serial OFDM symbol to parallel format and applies the OFDM symbols to the inputs of Fast Fourier Transform (FFT) block 320. FFT block 320 performs an FFT operation and the data output by FFT block 320 is stored in buffer 325 for further processing.

In one processing step, broadcast demodulation and decoding block 330 receives the broadcast pilot signals from FFT block 320 and demodulates and decodes the broadcast information from the data in buffer 325. The decoded broadcast information is stored in broadcast information buffer 335. In another processing step, broadcast encoding block 340 re-encodes the decoded broadcast information in buffer 335 using the broadcast pilot estimates from FFT block 320. In essence, this operation reconstructs the broadcast signal. Cancellation block 345 then cancels (i.e., subtracts) the reconstructed broadcast signal from the buffered overall signal in buffer 325, thereby removing the effect of the broadcast signal from the overall signal. Thus, the output of cancellation block 345 is the resulting overall unicast signal.

Unicast demodulation and decoding block 350 then demodulates and decodes the resulting unicast signal from cancellation block 345 using the unicast pilot estimates from FFT block 320. SS 116 then uses the decoded unicast signal from unicast demodulation and decoding block 350. Ideally, the broadcast and the unicast streams are thereby recovered error free.

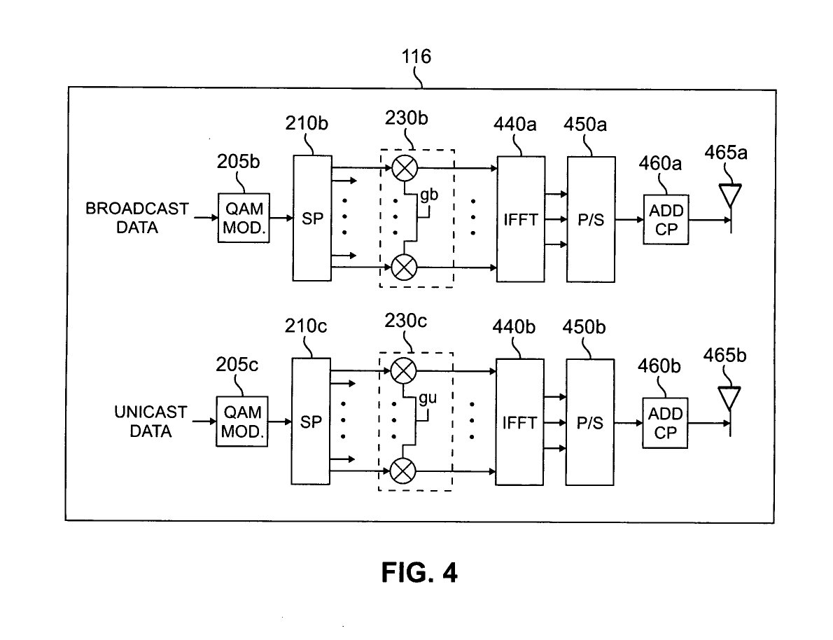

FIG. 4 is a high-level diagram of base station 102, which superimposes broadcast traffic on unicast traffic in the downlink according to an alternate embodiment of the present disclosure. In the alternate embodiment, the broadcast and unicast traffic are transmitted using the same OFDM subcarriers but from different antennas. Thus, the broadcast and unicast data are combined in the air, rather than by adder block 235.

In the embodiment in FIG. 4, two transmit paths are implemented. A first transmit path comprises QAM block 205b, serial-to-parallel (S/P) block 210b, gain multiplier block 230b, inverse Fast Fourier Transform (IFFT) block 440a, parallel-to-serial (P/S) block 450a, add cyclic prefix (CP) block 460a and antenna 465a. A second transmit path comprises QAM block 205c, serial-to-parallel (S/P) block 210c, gain multiplier block 230c, inverse Fast Fourier Transform (IFFT) block 440b, parallel-to-serial (P/S) block 450b, add cyclic prefix (CP) block 460b and antenna 465b. The operations of each of the functional blocks in the two transmit paths is analogous to the operations of the corresponding functional blocks in FIG. 2 and need not be explained in further detail.

The first transmit path receives, encodes and modulates the broadcast data and the second transmit path receives, encodes and modulates the unicast data. However, the encoded and modulated broadcast and unicast streams are mapped to the same OFDM subcarriers using separate IFFT blocks 440 and 440b. The broadcast stream outputs of IFFT block 440a are transmitted from antenna 465a. The unicast stream outputs of IFFT block 440b are transmitted from antenna 465b. Since both broadcast and unicast streams are transmitted using the same bandwidth (i.e., the same set of subcarriers), the broadcast and unicast signals are superimposed in the air after transmission from antennas 465a and 465b.

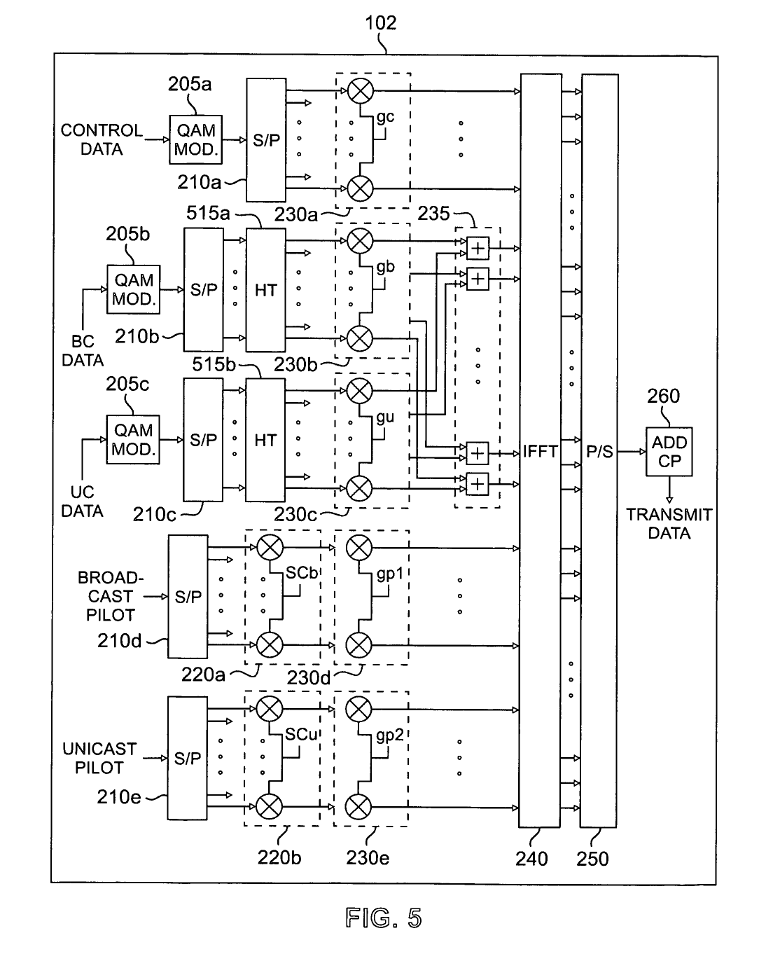

FIG. 5 is a high-level diagram of base station 102 according to an alternate embodiment of the present disclosure. FIG. 5 is substantially identical to FOGURE 2, except that Hadamard Transform (HT) blocks 515a and 515b are inserted in the processing paths of the broadcast data and unicast data, respectively. The Hadamard Transform operations are performed on both the broadcast and unicast modulation symbols before mapping to the subcarriers at the inputs of IFFT block 240. The Hadamard Transform operation allows spreading the modulation symbols over multiple carriers, thereby providing frequency-diversity in a frequency-selective wireless multipath channel.

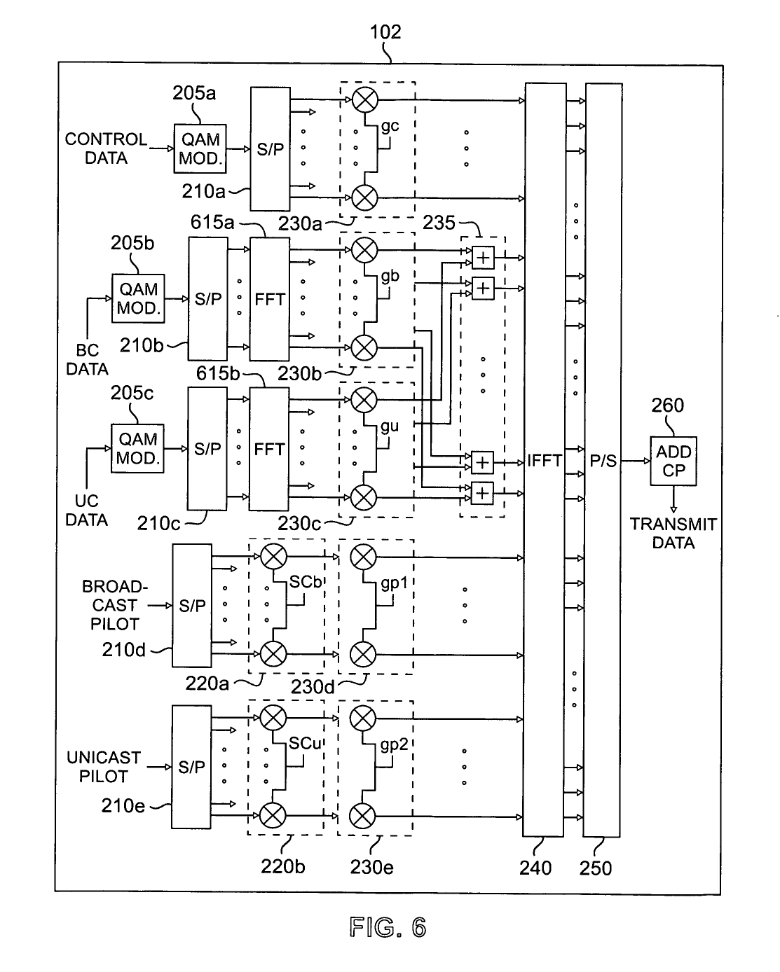

FIG. 6 is a high-level diagram of base station 102 according to an another alternate embodiment of the present disclosure. FIG. 6 is substantially identical to FIG. 2, except that FFT pre-coding blocks 615a and 615b are inserted in the processing paths of the broadcast data and unicast data, respectively. The FFT pre-coding operations are performed on both the broadcast and unicast modulation symbols before mapping to the subcarriers at the inputs of IFFT block 240. Similar to the Hadamard Transform operations, the FFT pre-coding operations allow spreading the modulation symbols over multiple carriers, thereby providing frequency-diversity in a frequency-diversity wireless multipath channel. Techniques for Fourier Transform pre-coding of transmit signals are disclosed in U.S. patent application Ser. No. 11/374,928, filed Mar. 14, 2006, and entitled “Apparatus And Method For FT Pre-Coding Of Data To Reduce PARR In A Multi-Carrier Wireless Network.” The drawings and specification of U.S. patent application Ser. No. 11/374,928 are hereby incorporated by reference as if fully set forth herein.

It is noted that a Hadamard Transform operation or an FFT pre-coding operation may be performed on only one of the broadcast and unicast streams in order to meet certain performance and complexity targets. Moreover, the broadcast and unicast streams after Hadamard Transform or FFT pre-coding operations may also be mapped to separate IFFTs and transmitted over different antennas, as in FIG. 4.

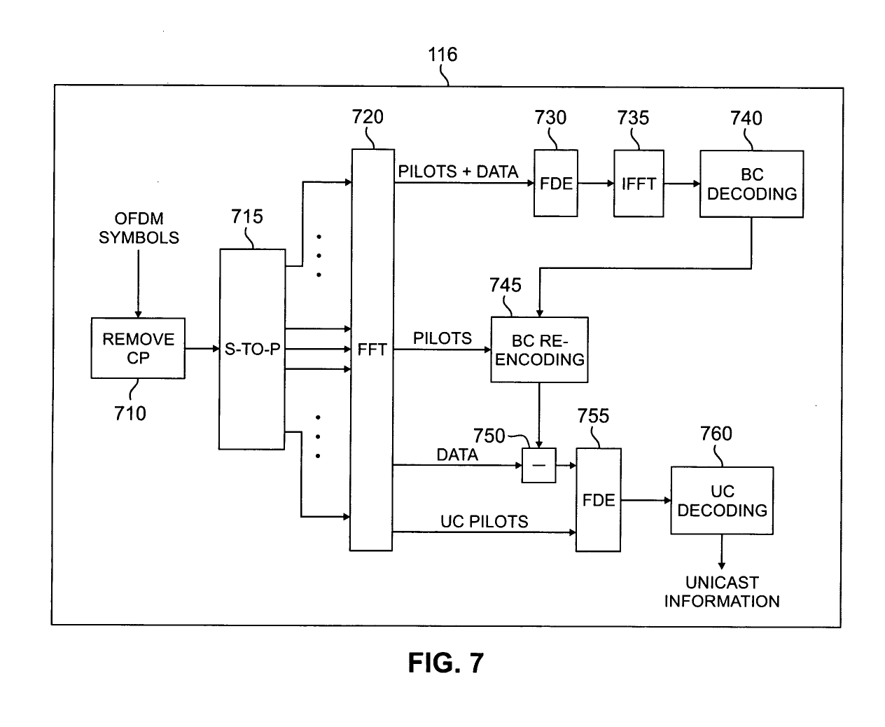

FIG. 7 illustrates exemplary subscriber station (SS) 116 in greater detail according to one embodiment of the present disclosure. FIG. 7 illustrates the functional blocks that perform interference cancellation of the broadcast signal in the OFDM receiver of SS 116 when the broadcast stream has been FFT pre-coded as in FIG. 6. After down-conversion (not shown) of the received RF signal, remove cyclic prefix (CP) block 710 receives the incoming OFDM symbols and removes the cyclic prefix associated with each OFMD symbol. Serial-to-parallel block 715 converts the serial OFDM symbol to parallel format and applies the OFDM symbols to the inputs of Fast Fourier Transform (FFT) block 720. FFT block 720 performs an FFT operation and the data output by FFT block 720 is then processed by frequency-domain equalizer (FDE) 730, IFFT block 735, broadcast (BC) decoding block 740, broadcast (BC) re-encoding block 745, cancellation block 750, frequency-domain equalizer (FDE) 755, and unicast (UC) decoding block 740.

FDE 730 receives the broadcast pilot signals and broadcast data from FFT block 720. FDE 730 uses the known broadcast pilot signals to perform frequency-domain equalization on the broadcast data symbols. IFFT block 735 receives the equalized broadcast data and reverses the FFT pre-coding operation performed by FFT block 615a in FIG. 6. Broadcast decoding block 740 then decodes the broadcast symbols to recover the original broadcast data stream.

Broadcast re-encoding block 745 uses the broadcast pilot signal estimates to re-encode the broadcast data stream. Cancellation block 750 then cancels (i.e., subtracts) the re-encoded broadcast stream from the overall received signal at the output of FFT block 720. The output of cancellation block 750 comprises the received unicast signal, because the effect of the broadcast signal has been eliminated. FDE 755 then performs frequency-domain equalization on the received unicast signal. Unicast decoding block 760 then decodes the equalized unicast signal to recover the original unicast data stream. It should be noted that if the unicast traffic was FFT pre-coded by FFT block 615b in base station 102, then an IFFT operation (not shown) would also performed on the unicast data at the output of FDE 755.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in an orthogonal frequency division multiplexing (OFDM) wireless network capable of communicating with a plurality of subscriber stations in a coverage area of the OFDM wireless network, a base station capable of transmitting a first OFDM symbol in a first time slot, wherein the first OFDM symbol comprises a first plurality of subcarriers in which broadcast data directed to a first plurality of subscriber stations is superimposed on unicast data directed to at least one selected subscriber station.

2. The base station as set forth in claim 1, wherein the first plurality of subcarriers are distributed across a frequency spectrum allocated to the first OFDM symbol.

3. The base station as set forth in claim 1, wherein the base station is capable of adjusting a broadcast gain factor, gb, used to control the transmit power of the broadcast data in the first plurality of subcarriers.

4. The base station as set forth in claim 3, wherein the base station is capable of adjusting a unicast gain factor, gu, used to control the transmit power of the unicast data in the first plurality of subcarriers.

5. The base station as set forth in claim 4, wherein the first OFDM symbol further comprises a second plurality of subcarriers used to transmit a broadcast pilot signal directed to the first plurality of subscriber stations and a third plurality of subcarriers used to transmit a unicast pilot signal directed to the at least one selected subscriber station.

6. The base station as set forth in claim 5, wherein the base station is capable of adjusting a broadcast pilot gain factor, gp1, used to control the transmit power of the second plurality of subcarriers.

7. The base station as set forth in claim 6, wherein the base station is capable of adjusting a unicast pilot gain factor, gp2, used to control the transmit power of the third plurality of subcarriers.

8. An orthogonal frequency division multiplexing (OFDM) wireless network comprising a plurality of base stations capable of communicating with a plurality of subscriber stations in a coverage area of the OFDM network, wherein each of the plurality of base stations is capable of transmitting a first OFDM symbol in a first time slot, wherein the first OFDM symbol comprises a first plurality of subcarriers in which broadcast data directed to a first plurality of subscriber stations is superimposed on unicast data directed to at least one selected subscriber station.

9. The OFDM wireless network as set forth in claim 8, wherein the first plurality of subcarriers are distributed across a frequency spectrum allocated to the first OFDM symbol.

10. The OFDM wireless network as set forth in claim 8, wherein the base station is capable of adjusting a broadcast gain factor, gb, used to control the transmit power of the broadcast data in the first plurality of subcarriers.

11. The OFDM wireless network as set forth in claim 10, wherein the base station is capable of adjusting a unicast gain factor, gu, used to control the transmit power of the unicast data in the first plurality of subcarriers.

12. The OFDM wireless network as set forth in claim 11, wherein the first OFDM symbol further comprises a second plurality of subcarriers used to transmit a broadcast pilot signal directed to the first plurality of subscriber stations and a third plurality of subcarriers used to transmit a unicast pilot signal directed to the at least one selected subscriber station.

13. The OFDM wireless network as set forth in claim 12, wherein the base station is capable of adjusting a broadcast pilot gain factor, gp1, used to control the transmit power of the second plurality of subcarriers.

14. The OFDM wireless network as set forth in claim 13, wherein the base station is capable of adjusting a unicast pilot gain factor, gp2, used to control the transmit power of the third plurality of subcarriers.

15. For use in an orthogonal frequency division multiplexing (OFDM) network capable of communicating with a plurality of subscriber stations in a coverage area of the OFDM network, a method of transmitting broadcast and unicast data to the subscriber stations, the method comprising the step of
transmitting a first OFDM symbol in a first time slot, wherein the first OFDM symbol comprises a first plurality of subcarriers in which broadcast data directed to a first plurality of subscriber stations is superimposed on unicast data directed to at least one selected subscriber station.

16. The method as set forth in claim 15, wherein the first plurality of subcarriers are distributed across a frequency spectrum allocated to the first OFDM symbol.

17. The method as set forth in claim 15, further comprising the step of adjusting a broadcast gain factor, gb, used to control the transmit power of the broadcast data in the first plurality of subcarriers.

18. The method as set forth in claim 17, further comprising the step of adjusting a unicast gain factor, gu, used to control the transmit power of the unicast data in the first plurality of subcarriers.

19. The method as set forth in claim 18, wherein the first OFDM symbol further comprises a second plurality of subcarriers used to transmit a broadcast pilot signal directed to the first plurality of subscriber stations and a third plurality of subcarriers used to transmit a unicast pilot signal directed to the at least one selected subscriber station.

20. The method as set forth in claim 19, further comprising the step of adjusting a broadcast pilot gain factor, gp1, used to control the transmit power of the second plurality of subcarriers.

21. The method as set forth in claim 20, further comprising the step of adjusting a unicast pilot gain factor, gp2, used to control the transmit power of the third plurality of subcarriers.

22. A first subscriber station capable of communicating with an orthogonal frequency division multiplexing (OFDM) wireless network, wherein the first subscriber station is capable of receiving a first OFDM symbol in a first time slot, wherein the first OFDM symbol comprises a first plurality of subcarriers in which broadcast data directed to a first plurality of subscriber stations is superimposed on unicast data directed to at least one selected subscriber station.

23. The first subscriber station as set forth in claim 22, wherein the first subscriber station comprises broadcast demodulation and decoding circuitry capable of receiving broadcast pilot signals and combined broadcast and unicast data generated from the first OFDM symbol and extracting a broadcast data stream from the combined broadcast and unicast data.

24. The first subscriber station as set forth in claim 23, wherein the first subscriber station further comprises cancellation circuitry capable of cancelling the extracted broadcast data stream from the combined broadcast and unicast data to thereby recover unicast data directed to the first subscriber station.

25. For use in an orthogonal frequency division multiplexing (OFDM) wireless network capable of communicating with a plurality of subscriber stations in a coverage area of the OFDM wireless network, a base station capable of transmitting a first OFDM symbol in a first time slot from a first antenna and a second OFDM symbol in the first time slot from a second antenna, wherein the first OFDM symbol comprises a first plurality of subcarriers used to transmit broadcast data directed to a first plurality of subscriber stations and the second OFDM symbol comprises a second plurality of subcarriers used to transmit unicast data directed to at least one selected subscriber station, and wherein at least some of the first plurality of subcarriers and the second plurality of subcarriers are the same subcarriers, such that the broadcast data is superimposed on the unicast data during transmission through a communication channel.
